(19) United States
(12) Patent Application Publication
(10) Pub. No.: US 2006/0028166 A1
(43) Pub. Date: Feb. 9, 2006

(54) Photovoltaic device

(75) Inventors: Alexandre Closset, Geneve (CH); Diego Fischer, Neuchatel (CH)

Correspondence Address: PEARNE & GORDON LLP, 1801 EAST 9TH STREET, SUITE 1200, CLEVELAND, OH, 44114-3108, US

(73) Assignee: VHF Technologies SA, Le Locle (CH)

(21) Appl. No.: 11/211,780

(22) Filed: Aug. 25, 2005

(30) Foreign Application Priority Data
Jun. 23, 2003 (WO) PCT/EP03/50251
Feb. 25, 2003 (WO) PCT/EP03/01893

(51) Int. Cl. H02J 7/35

(52) U.S. Cl. 320/101

(57) ABSTRACT

A portable solar charger (2), comprising a flexible solar panel (23) rollable on a cylindrical stiff core (12). The device comprise a flexible protection (32) fully encircling the solar panel (23) when in the rolled position. The device provides superior portability and ruggedness for indoor and outdoor applications.

### REFERENCE DATA

This application is a continuation of International Patent Application 2003WO-EP50251 (WO04077577) filed on Jun. 23, 2003, under priority of International Patent Application 2003WO-EP01893 (WO04077576) of Feb. 25, 2003, the contents of which are hereby incorporated by reference.

### FIELD OF THE INVENTION

The present invention deals with a portable photovoltaic device and particularly with a photovoltaic portable solar panel to be employed especially, but not exclusively, for recharging portable electronic appliances like cell phones, PDA, personal computers, GPS receivers, handheld two-way radios, MP3 or CD players and so forth.

### DESCRIPTION OF RELATED ART

The market offers nowadays a large selection of portable electronic devices, whose applications cover a multitude of fields, comprising cell phones, personal computer or PDA, GPS, handheld radios, movie and still cameras, music players, entertainment devices and many others.

All these devices and gadgets depend for their functioning from an electrical energy source, and are generally equipped with rechargeable batteries which must be replenished regularly after use, which task is generally accomplished by an appropriate charger unit, specific to each particular device, to plug into an AC mains socket. As it is well known to anybody who relies on these devices on travel, this recharging procedure is particularly inconvenient during voyages, where AC sources are not readily available. It is particularly awkward, for the traveller, to equip himself or herself with adapters for the different mains socket varieties which may be found in foreign countries. Moreover, it is often difficult to find a freely available AC connection, for example in an airport lounge or in a railway station.

The above difficulties are even more serious in case of outdoor activities. In these situations telecommunication devices are often used for routine communications, and also for emergency and distress calls. GPS receivers are also commonly employed for orienteering and navigation. The scarcity or lack of reliable AC sources outdoor severely limits the use of these valuable devices.

In order to address these limitations, it has been proposed to recharge the batteries with a portable solar charger, or with solar panels integrated in the portable appliances. Solar battery chargers usually comprise a solar panel comprising a plurality of solar cells for transforming solar energy into electrical energy, control electronics for controlling the output voltage, and a connector for connecting the electronic device, the batteries to be charged or another charger.

Solar battery chargers should thus preferably be light-weight and small in order to be easily transported when traveling, or stored when not in use. The surface of the solar panel is therefore limited by the size of the charger, limiting in turn the electrical power generated by the solar charger, as this power is directly proportional to the surface of the solar panel. This limitation can lead to very long charging times for high capacity batteries, thus rendering the charger unpractical, or even unsuitable, for some applications.

In order to increase their power generation capacity without significantly impairing their handiness, some prior art solar chargers are provided with foldable solar panels made of a plurality of rigid panel elements. Each panel element is held within a rigid frame which is mechanically and electrically connected to one or more other frames, each holding another panel element. When the solar charger is in use, i.e. in its operating position, the solar panel is unfolded and exposed under a light source. In its resting position, the solar panel is folded and the dimensions of the charger's larger surface are usually approximately equivalent to the dimensions of a single panel element. The total surface of the solar panel in its operating position can thus be larger than the largest surface of the solar charger when the solar panel is in its resting position. In practice, however, the number of panel elements is rarely larger than four, because of the weight and thickness of each panel element negatively impacting the overall weight and thickness of the solar charger and because the fragility of the solar panel increases with the number of panel elements, while its handiness decreases.

A limitation of the above portable solar chargers is that they may be difficult to pack in a backpack, or in a business case, because of their rigid shape. Moreover, although a foldable panel may conveniently be rested on a desktop or on a flat surface, this position is not adequate for many outdoor applications, like camping and boating, where stable flat resting surfaces are not available.

Another solution for increasing the power generation capacity of a photovoltaic device without significantly impairing its handiness is to use a flexible solar panel which can be rolled in its resting position and unrolled for operating purposes.

U.S. Pat. No. 5,605,769 for instance describes an apparatus for supplying electrical energy to battery powered equipment, comprising a flexible solar panel. The apparatus described in this document is basically a rechargeable battery associated to its own solar panel which will generate the electrical energy necessary for its recharge. When the apparatus is being used, it is placed within the battery compartment or battery holder of the battery-powered equipment. When the battery is empty, the apparatus is taken out of the equipment. The flexible solar panel is unrolled and exposed to a source of light. It generates electrical energy which is directly and uniquely used for recharging its associated battery.

Moreover, this apparatus has several drawbacks. In particular that its size and its shape as well as the size, the shape and the position of its connectors must comply with the existing and strongly established norms in order for it to fit within the battery compartment of a battery operated equipment. It can thus only be used within equipments requiring one specific type of batteries. Moreover, the rechargeable battery and its associated flexible solar panel must both fit within the space which is normally reserved for the battery only. The capacity of the apparatuses battery is thus significantly reduced compared to that of a battery having the same size as the apparatus, making it probably unsuitable for most applications. The size of the solar panel is also limited by the space available around the battery part, up to the normalized outer diameter.

Another drawback of the apparatus described in U.S. Pat. No. 5,605,769 is that it can easily be damaged during its transport or insertion within the battery compartment or battery holder of the battery-powered equipment, as the flexible solar panel in its resting position remains uncovered on a significant portion of the apparatus's circumference. The handle portion attached to the extremity of the flexible solar panel must stay sufficiently open in order for it to be placed around the folded solar panel and taken away from this resting position without damaging the solar cells.

Another drawback of the apparatus described in U.S. Pat. No. 5,605,769 is that it must be hung by its handle portion in order for the solar panel to keep in a fully stretched operating position. The solar panel is then oriented vertically, which is far from the ideal operating position, where the solar panel is perpendicular to the incident light.

Furthermore, the device described in U.S. Pat. No. 5,605,769 can be used for recharging the enclosed battery only when the battery is not in use. It does not allow recharging the battery and, at the same time, using the generated solar power for an electrical appliance.

### BRIEF SUMMARY OF THE INVENTION

An aim of the present invention is to propose a photovoltaic device avoiding the drawbacks of prior art solar chargers.

This aim is achieved by a device having the characteristics of the first independent claim, further advantageous embodiments being given by the dependent claims.

In particular this aim is achieved by a photovoltaic device comprising a solar panel, a stiff core, flexibly connected with one extremity of said solar panel and a protection flap, flexibly connected with another extremity of said solar panel; said photovoltaic device allowing a deployed position, in which said solar panel is unrolled to expose an active surface of said solar panel to ambient light, and a storage position in which said solar panel is rolled around said stiff core, and said protection flap is rolled around said solar panel, and said protection flap completely protect said solar panel.

### BRIEF DESCRIPTION OF THE DRAWINGS

The present invention will be better understood with the help of the appended claims and of the description illustrated by the FIGS. 1 to 3 where:

FIG. 1 represents a flexible solar charger according to the invention;

FIG. 2 represent a variant embodiment of a flexible solar charger according to the invention;

FIGS. 3 and 4 represent, in detail two variant realisations of a device for guiding the user in the storage of a solar charger according to the invention.

FIG. 5 represents a further variant of the device according to the invention, wherein the flexible panel is rolled in the opposite direction with respect to the solar charger of FIG. 1.

### DETAILED DESCRIPTION OF THE INVENTION

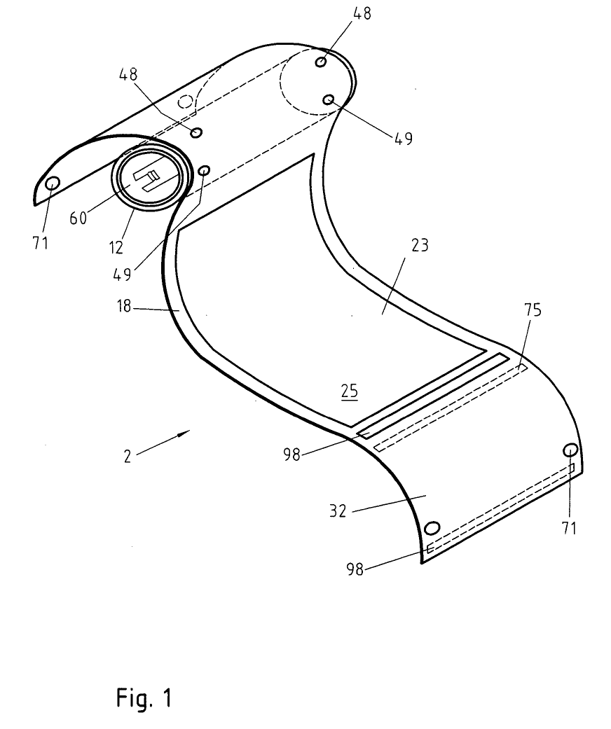

The flexible solar charger represented on FIG. 1 represents an embodiment of the present invention. It comprises a flexible photovoltaic device 23 for the direct conversion of solar or artificial light into electric power. The flexible solar panel 23 is preferably made of flexible photovoltaic cells, such as for example amorphous silicon solar cells, cadmium telluride solar cells, copper indium diselenide solar cells or organic dye, deposited on a very thin and flexible substrate such as for instance a film of polyimide, polyethylene naphtalate. In a variant embodiment, the flexible solar panel 2 is made of conductive polymer layers. The present invention is not however limited to these examples, but rather comprises any other suitable material of combination of materials, including, for the substrate, thin metal sheets. In order to improve the solar panel's mechanical resistance and to protect the solar cells from damages, it is preferably further laminated in a thin transparent flexible packaging film.

It is a characteristic of flexible solar panels, that they have a minimum bending diameter, and can be safely bent provided the diameter of curvature does not go below the minimum bending diameter. It is of course desirable that the minimum bending diameter should be as low as possible. To this effect the thickness of the active photovoltaic layer, of the substrate and of the protective packaging should to be kept low, in order to allow the device to bend on a tight diameter without inducing excessive stress in the photovoltaic layer.

Preferably the photovoltaic layer will be not thicker than 1 μm, and the substrate will not be thicker than 50 μm. In this way bending diameters as low as 1 cm can be achieved for the unpackaged solar panel. The packaging protective layers should also be as thin as possible. The minimum bending diameter of a packaged solar panel will be somewhat increased with respect to the unpackaged device. In the case of the above example, a typical figure of minimum bending diameter for the packaged solar panel would be about 2 cm.

In this particular example the solar panel 23 has a surface of 30×60 cm², and delivers a maximum power of 5 W at full sun light. Such power is sufficient to recharge most portable devices in a reasonable time, even in moderately overcast weather. Of course other choices of dimensions and power are equally possible, within the frame of the invention, according to the intended use and to the characteristics of the solar cells employed.

The solar panel 23 is permanently fixed on a flexible fabric sheet 18, leaving the active surface 25 of the panel 23 exposed. The fabric material can be a woven or non-woven natural or preferably synthetic fibre, like for example nylon or polyester. In a first variant the solar panel 23 is sewn by its inactive border portion on the sheet 18. Where desirable, however the solar panel 23 can be glued or bonded to the textile sheet 18 by contact glue, hot-melt glue, adhesive tape, plastic welding by heat or ultrasound, or by any other technique or combination of techniques. In particular the solar panel 23 may be glued, taped or welded on the fabric 18, and the union between the solar panel 23 and the sheet 18 may then further be reinforced with stitches.

The flexible charger 2 comprises also a stiff cylindrical core 12, on which the textile sheet 18 and the solar panel 23 are rolled when not in use. The diameter of the cylindrical core 12 is chosen not to exceed the tightest rolling radius allowed by the solar panel 23. In this particular example the solar panel 23 allows a minimal rolling radius of 10 mm, when rolled with the active surface 25 on the outside, and the cylindrical core has a diameter of 25-30 mm. Of course this numerical value could be adapted, according to the circumstances and to the characteristics of the solar panel 23 and of the textile material chosen. For example a core diameter of 50, 70, 80 or 100 mm could be adopted.

The sheet 18 is permanently fixed to the core 12 by the four rivets 48, 49, or by any other suitable fixation means.

The length of the sheet 18 exceeds the length of the solar panel 23, so to provide two flexible flaps 31 and 32, on either sides of the solar panel 23. The flap 32, at the extremity of the sheet 18 further from the core 12, has the function to protect the solar panel 32 when not in use, and is dimensioned to completely cover the solar panel in the rolled up position. To prevent the roll from undoing, the flap 32 carries appropriate fixation means, for example interlocking “Velcro®” bands 98, or other suitable fixation means, like buttons, zips, laces or other.

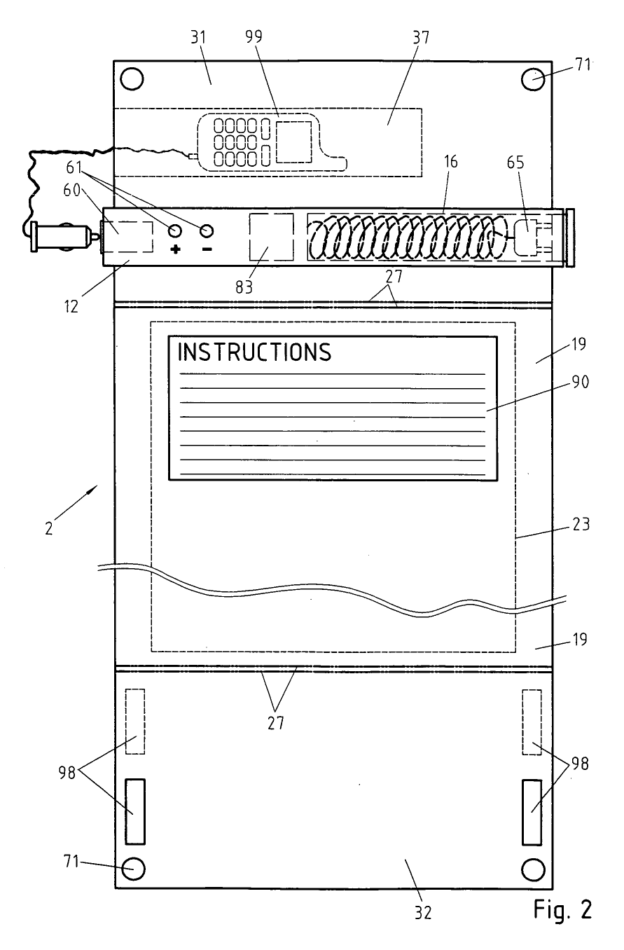

The second flap 31 (see FIG. 2), on the extremity of the sheet 18 closer to the core 12, has two grommets, or eyelets, 71, for hanging or suspending the charger 2 when in use. A second pair of grommets 71 is also provided on the first flap 32.

The generated electrical energy is accessible through an electric connector 60 having preferably two electric poles across which the charger's output voltage is present. The connector 60 is preferably embedded in one of the two extremities of the cylindrical core 12. The one skilled in the art will recognize that any other type of electric connector can be used within the frame of the invention. They can either be of a normalized type or a brand-specific type, depending on the intended use of the charger.

The connector preferably is of a common and standardized type, such as for example the connectors used in cars for cigarette lighters. The choice of a cigarette lighter type of connector is particularly favorable, because car adaptors exist, and are readily available, for practically all portable devices. A wide range of electronic appliances and/or standard connection cables can thus be connected to it without requiring additional or ad hoc adaptors.

In order to guide the user and ensure a correct rolling, the device comprises also a stiffening rod 75, preferably hidden in a pocket of the fabric 18, for ensuring that the solar cell is rolled straight on the core 12. Without the stiffening rod 75, creases may form, which could damage the solar cell 23. For lightness' sake the rod 75 may be realized of carbon fibers or foamed resin, life for example polyurethane resin.

The outer diameter of the core 12 will naturally be chosen as small as the flexibility of the solar panel 23 allows, in order to obtain a tight roll, with safety to the photovoltaic layer. With the ultra-thin layer mentioned above outer diameter less than 5 cm can be achieved, for example 3 cm. According to the chosen materials and processes, diameters of 5, 7 or 10 cm are also possible.

FIG. 2 represents a variant embodiment of the charger unit 2 according to the invention, laid flat and seen from its backside.

In this embodiment the solar cell 23 is laminated on a plastic film 19, rather than sewn on a textile sheet. The textile flaps 31 and 32 are then attached to the film 19 along the two seams 27. The attachment may, as in the previous embodiment, be realized by sewing, gluing, welding, taping, or any other technique or combination of techniques.

In an alternative variant embodiment, the flaps 31 and 32 are realized from extensions of the same plastic film 19, thus providing a seamless construction for the solar charger 2. A textile backing may optionally be added, for aesthetic reasons, on the side of the plastic film 19 opposed to the solar panel 23.

The stiff core 12 comprises, at one end, a cigarette lighter socket 60, for providing electrical connection with the device to be charged. At the same time the charger 2 provides also other kind of connectors, in this case the banana connectors 61 placed on the lateral surface of the cylindrical core 12, for added flexibility and ease of operation. The connectors 61 may be used to connect external devices for which no car adaptors are available, or also for connecting two or more solar chargers 2 together to increase the delivered power.

Alternatively, auxiliary electrical connectors may be placed on the opposite base of the core 12 with respect to the cigarette lighter socket 60. In this case the auxiliary electrical connector may be any kind of connector or preferably a second cigarette lighter socket (not represented). Double male cigarette lighter plugs or cables may be used in the latter case for connecting two or more solar chargers in parallel.

A hollow compartment 16 is provided at the other end of the stiff core 12, for storing accessories or other ancillary devices. The hollow compartment 16 may be used, for example, to conveniently store connection cables 65 for the auxiliary 61 connectors.

In a variant embodiment of the present invention, the available volume in the core 12 may be used to lodge permanently or detachably other electrical or electronic devices, alimented or recharged by the solar panel 23. For example the core 12 may comprise a pocket lamp, a radio, a GPS receiver, an audio device and so forth.

The solar charger 2 according to this embodiment of the present invention further comprises control electronics 83, housed within the core 12, for regulating the charger's output voltage. A selection means, such as for example a switch (not shown) is connected to the control electronics 83, allowing a user to select the desired output voltage among predefined sets of output voltage values. The predefined output voltage values may be for example 3 volts, 6 volts and/or 12 volts, which are the typical DC-output values for battery chargers. The one skilled in the art will however recognize that the solar charger's output voltage can be permanently set to a determined value, in which case no selection switch would be required. In a variant embodiment, the selection means do not have a set of discrete positions, allowing the output voltage to be set to any value between a minimal and a maximal value.

In a variant embodiment, the control electronics 83 further determines and controls charge cycles adapted to the type of batteries to be charged. The control electronics for instance includes a processor for automatically recognizing the type, for example the manufacturer and the model, of rechargeable battery connected to the charger and an EPROM containing the necessary data for adapting the charge cycles to that particular type of batteries. The data in the EPROM can preferably be modified at all times, allowing an adaptation of the solar charger to possibly new types of batteries. In another variant embodiment, the control electronics comprises a further selection means for manually selecting the correct type of charge cycles.

In a variant embodiment, the control electronics 83 further regularly measures and controls the charge level of the battery being charged, in order to avoid overcharging and possibly damaging it.

In a variant embodiment, the photovoltaic device further comprises an internal rechargeable battery. In order for the solar charger to be as compact as possible, the internal battery is preferably housed within the core 12. The internal battery can be charged by operating the solar panel 23 when no other rechargeable battery or electronic device is connected to the connector 60. The energy stored in the internal battery is then used later for providing additional electrical power to the power generated by the solar panel 23 when charging another rechargeable battery, or to recharge another battery when no light source is available.

FIG. 2 also shows an instruction panel 90, permanently fixed to the backside of the solar panel 2. The instruction panel 90 may be glued, sewn or preferably printed or serigraphed to the backside of the solar panel 2.

The embodiment presented on FIG. 2 also shows an alternative disposition of the Velcro® bands 98, which is more tolerant to misalignment in the rolling.

The solar panel of FIG. 2 comprises also a pocket 37, in which a portable device 99 can be conveniently lodged and protected during the charging time.

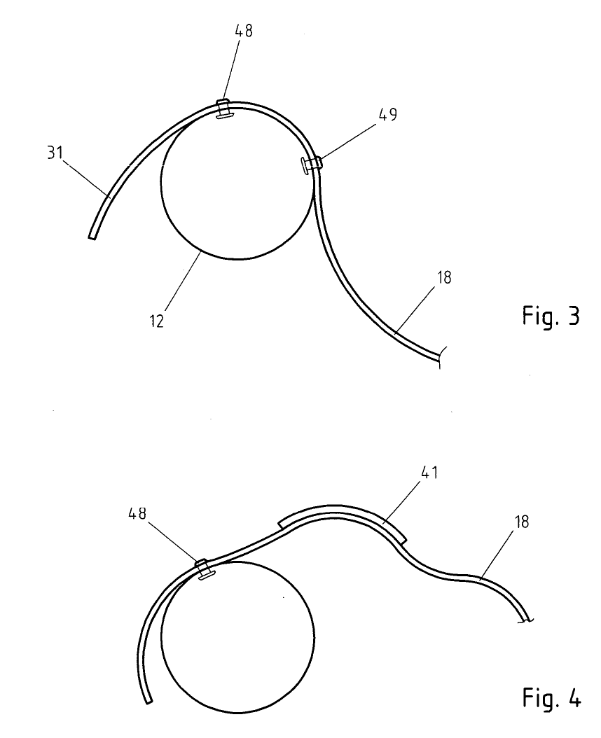

With reference now to FIGS. 3 and 4, an additional optional feature of the invention is described, which prevents the user from rolling the device in a wrong sense.

Flexible solar cells may have in fact a preferred curvature direction, and may allow a tighter rolling radius in a sense than in another. In this case the solar panel 2 may include foolproof features for preventing the user from rolling the device in the wrong sense.

If for example it is preferable to roll the solar panel with the active surface on the outside, than the stiff core 12 will preferably be fixed on the backside of the solar panel 2, as it is shown on FIGS. 1 and 2.

On the contrary, if the solar panel should withstand rolling stresses better when it is rolled with the active surface 25 on the inside, the stiff core would preferably be above the fabric sheet 18.

The above choice of the core position naturally hints to the user the preferred way of rolling up the flexible charger 2. Even so, it may still be possible for a user, to inadvertently roll up the flexible charger 2 in the wrong sense.

To further prevent a rolling in the wrong sense, the textile sheet 18 may be fixed to the core 12 by a double series of rivets 48, 49, as shown on FIG. 3, spaced along the circumference of cylindrical core 12, in order to force a part of the textile sheet 18 to roll around the core in the right sense.

FIG. 4 shows another kind of foolproof device, used to prevent a rolling of the textile sheet 18 in the unfavorable direction. In this case an elastic or stiff element 41 pre-bent with the radius of the core 12, mates the surface of the core only when the sheet 18 is rolled around the core 12 in the right sense.

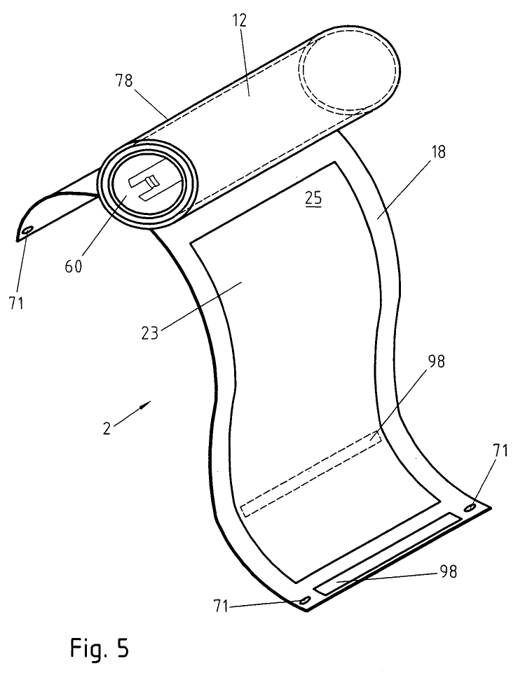

In another embodiment of the present invention, represented on FIG. 5, the diameter of the core 12 is chosen in order to allow the solar to be rolled with the active surface on the inside. This can be achieved for example by choosing a slightly larger diameter of the core. In this case the core will be fixed above the front side of the solar panel, and the protection flap 32, no longer necessary, is omitted. In the rolled up position the active surface 25 of the solar cell 23 is completely protected from the outside inside the roll. In this variant the core 12 may is inserted in a pocket 78, formed by sewing two juxtaposed fabric sheets, instead than, or in addition to, being fixed with rivets.

The solar charger 2 of the present invention can therefore be easily manufactured and, thanks to its flexibility, joins ruggedness and an attractive look. It does not include complex mobile parts, like articulations or hinges, which are costly to produce and are subject to frequent ruptures due to hard use or careless packing.

The skilled person will understand that many possible variations of the embodiments presented here by way of example are possible within the frame of the present invention. The present invention is not limited to the combination of features given in the proposed embodiments, but rather allows all possible variations, adaptations and combinations of features which fall within the broad scope of the appended claims.

1. Photovoltaic device comprising a solar panel, a stiff core, connected with one extremity of said solar panel; said photovoltaic device allowing a deployed position, in which said solar panel is unrolled to expose an active surface of said solar panel to ambient light, and a storage position in which said solar panel is rolled around said stiff core.

2. The photovoltaic device of claim 1, wherein said active surface is completely protected from the outside in said storage position.

3. The photovoltaic device of claim 1 or 2, further comprising and a protection flap, connected with another extremity of said solar panel; wherein in said storage position said protection flap is rolled around said solar panel, and said protection flap completely protects said solar panel.

4. The photovoltaic device of claim 3, further comprising an outlet socket, interoperable with a standard car cigarette lighter plug, for conducting a photovoltaic current produced by said solar panel.

5. The photovoltaic device of claim 1, wherein said solar panel comprises a flexible photovoltaic layer deposed over a flexible polymeric film.

6. The photovoltaic device of claim 1, wherein an outer diameter of said core is lower than 10 cm, and preferably lower than 7 cm.

7. The photovoltaic device of claim 1, wherein said solar panel is sewn on a flexible fabric sheet.

8. The photovoltaic device of claim 7, wherein said protection flap is integrally formed from an extension of said flexible fabric sheet.

9. The photovoltaic device of claim 7, wherein said protection flap is fixed to an extremity of said flexible fabric sheet, preferably sewn to said extremity of said flexible fabric sheet.

10. The photovoltaic device of claim 1, wherein said solar panel is laminated on a flexible substrate.

11. The photovoltaic device of claim 1, wherein said protection flap is fixed to an extremity of said flexible substrate, preferably sewn to said extremity of said flexible fabric sheet.

12. The photovoltaic device of claim 1, further comprising a stiff element parallel to said stiff core, connected with said other extremity of said solar panel.

13. The photovoltaic device of claim 1, further comprising electrical storage means.

14. The photovoltaic device of claim 1, further comprising an electric plug, for connecting together other similar photovoltaic devices.

15. The photovoltaic device of claim 1, wherein said stiff core comprises a storage space for accessories.

16. The photovoltaic device of claim 1, further comprising hanging means, preferably one or more grommets, for hanging said device when in said deployed position.

17. The photovoltaic device of claim 1, further comprising maintain means, preferably a pair of interlocking “Velcro” ribbons, for maintaining said device in said storage position.

18. The photovoltaic device of claim 1, wherein said solar panel has a favorable rolling direction, and an unfavorable rolling direction, further comprising means to prevent said unfavorable rolling direction.
